(19) United States
(12) Patent Application Publication
(10) Pub. No.: US 2002/0146956 A1
(43) Pub. Date: Oct. 10, 2002

(54) Bi-Functional nonwoven fabric wipe

(76) Inventor: Mou-Chung Ngai, Boxmeer (NL)

Correspondence Address: ROCKEY, MILNAMOW & KATZ, LTD., TWO PRUDENTIAL PLAZA, STE. 4700, 180 NORTH STETSON AVENUE, CHICAGO, IL, 60601, US

(21) Appl. No.: 09/997,673

(22) Filed: Nov. 29, 2001

Related U.S. Application Data
(60) Provisional application No. 60/253,875, filed on Nov. 29, 2000.

(51) Int. Cl. B32B 5/02; B32B 27/04; B32B 27/12; D04H 1/00; D04H 3/00; D04H 5/00; D04H 13/00; B32B 5/26; B32B 5/06

(52) U.S. Cl. 442/381; 442/327; 442/389; 442/148

(57) ABSTRACT

A bi-functional nonwoven fabric wipe embodying the principles of the present invention comprises a hydroentangled, composite fibrous matrix having first and second, opposite expansive surfaces. The first expansive surface of the wipe is provided by a first outer layer of the composite fibrous matrix, with this surface exhibiting a relatively soft, smooth surface texture. In contrast, the second, expansive surface is provided by a second outer layer of the composite fibrous matrix, and exhibits a relatively abrasive surface texture. By the differing surface textures of the opposite expansive surfaces, the present wipe is provided with bi-functional characteristics, thus enhancing versatile use for cleaning applications.

### TECHNICAL FIELD

The present invention relates generally to a nonwoven fabric wipe suited for cleaning and like applications, and more particularly to a bi-functional wipe having opposite expansive surfaces, one of which is relatively soft and absorbent, and the other of which is relatively abrasive for enhanced scrubbing characteristics. The relatively soft surface of the wipe consists essentially of cellulosic fibers, preferably rayon, while the opposite, relatively abrasive surface comprises a blend of cellulosic (rayon) and synthetic (PET) fibers. A binder composition may be applied to the relatively abrasive surface to enhance its abrasiveness. The wipe structure may be apertured for extra surface roughness and rigidity for enhanced scrubbing.

### BACKGROUND OF THE INVENTION

Nonwoven fabrics are used in a wide variety of applications where the engineered qualities of the fabrics can be advantageously employed. The use of selected natural and synthetic fibers in the construction of the fabric, together with the selected use of various mechanisms by which the fibers can be integrated into a useful fabric, are typical variables by which to adjust and alter the performance of the resultant nonwoven fabric. Various finishing processes may also be employed for affecting the physical properties and characteristics of the resultant fabric.

One type of application for which nonwoven fabrics have proven to be particularly suited is for formation of a so-called wipe, that is, a discrete piece of fabric which can be readily hand-held, such as for cleaning and the like. While fabrics of this nature are well-known in the prior art, the specific requirements for such an application can result in a compromise in the physical properties of a nonwoven fabric designed for such use. On the one hand, nonwoven fabric wipes are typically employed in a manner in which good liquid absorbency is desirably exhibited by the fabric. At the same time, it can be desirable for a wipe to exhibit sufficient physical integrity and abrasiveness to facilitate scrubbing with the wipe during cleaning. Naturally, wipes of this nature must be sufficiently durable as well as sufficiently inexpensive as to facilitate their cost-effective use.

The present invention contemplates a bi-functional nonwoven fabric wipe particularly configured to provide absorbency and abrasiveness, while permitting efficient formation for cost-effective use.

### SUMMARY OF THE INVENTION

A bi-functional nonwoven fabric wipe embodying the principles of the present invention comprises a hydroentangled, composite fibrous matrix having first and second, opposite expansive surfaces. The first expansive surface of the wipe is provided by a first outer layer of the composite fibrous matrix, with this surface exhibiting a relatively soft, smooth surface texture. In contrast, the second, expansive surface is provided by a second outer layer of the composite fibrous matrix, and exhibits a relatively abrasive surface texture. By the differing surface textures of the opposite expansive surfaces, the present wipe is provided with bi-functional characteristics, thus enhancing versatile use for cleaning applications.

In a preferred form of the present nonwoven fabric wipe, the first and second expansive surfaces of the composite fibrous matrix are of differing colors. The differing colors of the expansive surfaces may comprise colored fibrous elements provided in one of the first and second outer layers of the fibrous matrix. It is further contemplated that the differing colors of the first and second expansive surfaces may comprise a colored binder composition applied to the second, relatively abrasive expansive surface. Preferably, the binder composition is selected to enhance the surface abrasiveness of this side of the wipe, thus enhancing its suitability for scrubbing applications.

Whether or not the binder composition is selected to provide the differing color characteristics for the opposite expansive surfaces of the present wipe, application of a binder composition to the second surface is preferred for enhancing its surface abrasiveness. The binder composition may be scatter-applied, or may be pattern-applied. The wipe structure may be apertured for extra surface roughness, thereby enhancing its scrubbing characteristics.

It is presently preferred that the relatively soft, first expansive surface of the present wipe is provided by forming the first outer layer of the fibrous matrix substantially entirely of cellulosic fibrous material, preferably viscose rayon. This layer functions as the major absorbent side of the composite structure. The second outer layer of the fibrous matrix preferably comprises a blend of cellulosic and synthetic fibers, and may preferably comprise viscose rayon, and high denier polyethylene terephthalate (PET) to provide the desired abrasive properties for the second expansive surface of the wipe.

The present nonwoven fabric wipe may further be configured such that the composite fibrous matrix of the wipe comprises an intermediate layer positioned between the first and second outer layers. The intermediate layer preferably consists essentially of synthetic fibers, such as polypropylene (PP), PET, co-PET, or bi-component fibers. It is contemplated that the intermediate layer be hydrophobic in nature, with this layer desirably acting to minimize or prevent a pigmented binder from penetrating from the second abrasive side of the fabric to the first, relatively soft side.

Other features and advantages of the present invention will become readily apparent from the following detailed description, the accompanying drawings, and the appended claims.

### BRIEF DESCRIPTION OF THE DRAWINGS

FIG. 1 is a diagrammatic, perspective view of a bi-functional nonwoven fabric wipe embodying the principles of the present invention;

FIG. 2 diagrammatically illustrates the apparatus employed for determining the coefficient of friction of a nonwoven fabric article;

FIGS. 3A and 3B are photographs of the apparatus of FIG. 2;

FIG. 4 is a graph of frictional coefficient data for samples tested;

FIG. 5 is a diagrammatic illustration of a test apparatus for evaluating wiping/cleaning performance of tested samples;

FIGS. 6A, 6B, and 6C are photographs of the test apparatus of FIG. 5; and

FIG. 7 is a graph of wiping performance of tested samples.

### DETAILED DESCRIPTION

While the present invention is susceptible of embodiment in various forms, there is shown in the drawings, and will hereinafter be described, presently preferred embodiments, with the understanding that the present disclosure is to be considered as an exemplification of the invention, and is not intended to limit the invention to the specific embodiment illustrated.

The present invention is directed to a non-structured composite nonwoven fabric that provides bi-functional surfaces with different cleansing effects. Fabrics embodying the principles of the present invention are engineered to have a firm, rough open fibrous surface, combined with an open fibrous core for good scrubbing and wiping/dirt pick-up properties on one side, and a soft, smooth side with good absorbent characteristics on the opposite side. It is contemplated that nonwovens embodying the principles of the present invention are especially suitable as a wet wipe substrate for cleaning both domestic and industrial surfaces, and further for use in skin/facial cleaning. The present nonwoven fabric wipe can be provided in forms that are suitable for use as a dry wipe to absorb liquid, and to provide extra scrubbing effect, as needed.

Notably, it is presently preferred that the relatively firm/rough surface of the wipe be distinguishable by color, such as by the provision of colored fibers or a colored binder applied thereto. The color difference between the opposite expansive surfaces assists end-users to identify those surfaces of the wipe exhibiting differing surface characteristics. If desired, it is contemplated that fabrics embodying the principles of the present invention may be provided with differing color coding on the abrasive surface to denote varying degrees of abrasiveness for different wipes.

It is presently preferred that wipes embodying the principles of the present invention be formed by a spunlace process, that is, by hydroentanglement of a composite fibrous matrix formed of two or more layers, whereby the desired differing surface characteristics of the wipe are provided. In one form, fabrics embodying the principles of the present invention are non-apertured, with no visible holes imparted to the fabric attendant to hydroentanglement on an imaging drum or belt. Alternatively, it is within the purview of the present invention to form an apertured image in the fabric during hydroentanglement by appropriate use of a suitably patterned image transfer device.

As noted, the present fabric is configured to include a first relatively soft, absorbent surface, and a second, opposite, relatively rough and abrasive surface. The rough surface of the wipe provides improved cleansing and scrubbing properties. The firm, rough open fibrous surface of the second side, combined with an open fibrous core, helps to pick-up dirt, with penetration to the core of the fabric. The core of the fabric (configured as an optional intermediate layer between the first and second outer layers) can be engineered to exhibit different fibrous pore size and toughness characteristics than the outer layers, for intended cleaning applications. For example, the core of the fabric may be formed from synthetic fibers having a denier which differs from those used in the outer layers. The first, relatively smooth side of the fabric is engineered to exhibit good absorbency, and preferably consists essentially of cellulosic fibers, preferably viscose rayon.

The degree of abrasiveness of the relatively abrasive surface of the present wipe can be selectively varied, depending upon the specific fiber construction selected. By use of a relatively soft binder, or no binder composition, the relatively abrasive side of the fabric will exhibit a lesser degree of abrasiveness. In contrast, selection of a relatively hard binder composition, which can be either scatter-applied, or pattern-applied, can desirably enhance the abrasiveness of the surface of the fabric. The degree of abrasiveness can also be altered by the quantity of binder applied whereby the application of the same binder composition at a higher rate or dosing level will result in a higher degree of abrasiveness than if the binder composition were applied at a lower level.

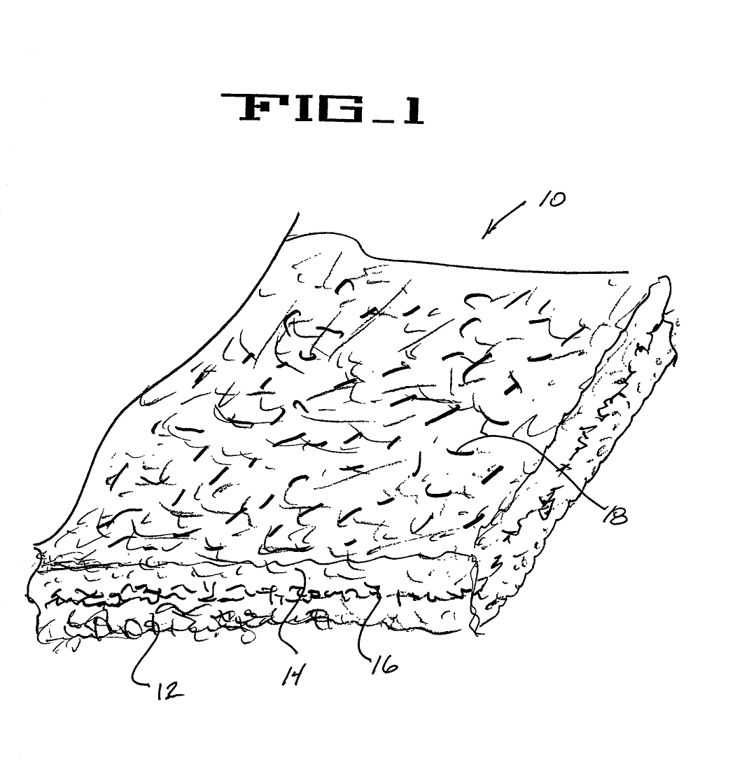

FIG. 1 illustrates a typical configuration of a bi-functional nonwoven fabric wipe embodying the present invention. The wipe structure, designated 10, preferably comprises a composite fibrous matrix including plural fibrous layers which are preferably integrated by hydroentanglement, such as by formation on a suitably foraminous drum or belt. Hydroentanglement of nonwoven fabrics is well-known in the prior art, such as exemplified by U.S. Pat. Nos. 3,498,874 and No. 3,485,706, to Evans, hereby incorporated by reference. Use of patterned, image transfer devices (ITD's) for formation of nonwoven fabrics is also known, such as exemplified by U.S. Pat. No. 5,144,711, to Drelich, hereby incorporated by reference. It is contemplated that selection of specific patterning for the present fabric can desirably enhance its scrubbing and cleansing characteristics.

As shown in FIG. 1, nonwoven fabric wipe 10 includes plural fibrous layers, including a first outer layer 12, and a second, opposite outer layer 14. The first and second outer layers respectively provide first and second expansive surfaces, which are specifically configured to exhibit differing characteristics, thus providing the desired bi-functionality for the present wipe. In particular, the first outer layer 12 is preferably formed substantially entirely of hydrophilic, cellulosic fibers, preferably viscose rayon, whereby this fibrous layer exhibits a relatively soft surface texture, and relatively good absorbency. If desired, sub-denier fibers in the form of spun micro-fibers or splittable conjugate fibers may be incorporated in the first fibrous layer for enhancing the softness of the first expansive surface of the wipe.

In contrast, the second outer fibrous layer 14, which provides the second expansive surface of the wipe, is selected such that the second expansive surface exhibits a relatively abrasive surface texture, thus suiting this side of the wipe for scrubbing and the like, where abrasiveness can be desired. It is presently contemplated that the second outer layer 14 comprise a blend of synthetic and cellulosic fibers, such as a blend of PET and viscose rayon fibers. By selecting the synthetic fibers of the second fibrous layer to be of a relatively high denier, surface abrasiveness of the expansive surface provided by the second layer is enhanced.

In the illustrated embodiment, the fibrous composite matrix includes an intermediate layer 16 positioned between the first and second outer layers 12, 14. The intermediate layer 16 is optionally provided in the wipe structure to create a barrier between the outer layers, thus permitting application of a binder composition to the second surface provided by the second layer, while abating penetration of the binder composition to the first outer layer.

FIG. 1 illustrates binder composition 18 as the composition would generally appear after scatter-application to the second fibrous layer. The binder composition is selected to exhibit the desired degree of abrasiveness, with various binder compositions being relatively soft or relatively hard, whereby the ultimate abrasive characteristics of the present wipe can be varied by selection of a suitable binder composition. Pattern-application of the binder composition can alternatively be effected.

The bi-functional characteristics of the present wipe are highlighted to the end user by providing the opposite, first and second expansive surfaces of the wipe with differing colors. This color differentiation can be achieved in a variety of ways. Because use of a binder composition is contemplated for many applications in order to provide the second surface of the wipe with the desired degree of abrasiveness, use of a pigmented or colored binder composition can provide the desired color differentiation between the opposite surfaces of the wipe. Alternatively, the fibers of one of the first and second outer layers of the wipe (such as the second, relatively abrasive layer) can be provided with pigmented or otherwise colored fibers, thus providing the desired color differentiation between the surfaces of the wipe.

### EXAMPLES

Five samples of the present nonwoven wipe were manufactured out of varying fiber compositions. The samples were formed to exhibit a fabric weight on the order of 55 grams per square meter.

Sample A included a first outer layer 12 of 100% viscose rayon, and a second outer layer 14 of a blend of 50% (by weight) of 1.7 decitex viscose rayon/50% 6.7 decitex PET, with scattered binder applied thereto. No intermediate layer 16 was employed.

Sample B included first and second outer layers as described above in Sample A, with this Sample further including an intermediate fibrous layer 16 of 100% 1.7 decitex PET fibers.

Sample C was the same as Sample A described above, except the second outer layer 14 comprised a blend of 25% 1.7 decitex viscose rayon, and 75% 6.7 decitex PET, with scattered binder application.

Sample D was the same as Sample C, but also included an intermediate layer 16 comprising 100% 1.7 dexitex PET fibers.

Sample E was the same as Sample D, but a more durable version thereof. The whole composite structure was pre-bonded with a small amount of polymer before the scatter hard polymeric binder coating was applied to the surface of layer 3.

Appended Table 1 shows the relative basis weights of the various layers of the above-described Samples, with the reference to “injectors” referring to the hydroentanglement process by which the fabrics were formed.

The first outer layer of the Samples contains inherently hydrophilic fibers in the form of 100% viscose rayon. This surface of the fabrics is smooth and soft, and is the main absorbent side of the composite structure. As noted, use of micro-fibers in this layer is within the purview of the present invention.

The intermediate layer (of Samples B, D, and E) contains 100% 1.7 decitex polyester fiber, but it is within the purview of the present invention that other synthetic fibers like polypropylene, PET/co-PET, or bi-component fibers could be employed. This intermediate layer is the hydrophobic layer of the fabric structure. The hydroentanglement process often makes the synthetic fiber layer relatively hydrophobic. It is contemplated that the main function of this layer is to prevent or minimize the penetration of pigmented binder composition from the second outer layer to the first outer layer during a scattered binder add-on application process.

The second outer layer of the Samples is made from a blend of viscose rayon and high decitex PET. By using high decitex PET the abrasive properties of the expansive surface provided by this layer is enhanced, together with the use of a relatively hard binder composition. The quantity of viscose rayon in this layer enhances fiber entanglement, especially when high decitex synthetic fibers, such as PET, are employed. To a certain extent, the viscose rayon also acts as the binder adsorption media for the whole composite construction. As noted, color can be delivered by incorporating pigment in the polymer binder. Extra abrasiveness can also be implemented by using a very hard binder composition. As noted, colored fibers can be used in this layer, instead of adding pigment to the polymeric binder.

Samples B, D, and E demonstrate the importance of 100% synthetic fibers in the intermediate layer. To a certain extent, this layer acts as a barrier layer for the binder to prevent or minimize penetration to the absorbent viscose rayon of the first outer layer 12. Sample B demonstrates that the existence of 100% synthetic fibers in layer 2 is very important if the second outer layer 14 is to comprise a blend of 50% or more of viscose rayon. The binder content of Sample A is also slightly higher due to the difficulty in controlling the binder migrating to the other side of the fabric. This fabric Sample is more compact, and has a rougher/tough surface texture. This can be a desirable characteristic for some applications.

Sample E shows that pre-bonding the whole composite structure with the correct technique helps to maintain the firm, rough open fibrous surface, and open fibrous core. This can be a preferred option especially as a wet wipe substrate because the whole composite construction is less susceptible to collapse in the wet stage.

Fabric compactness and the roughness/toughness of Samples A-E are different from each other depending on the fiber composition, which also effects the binder add-on and migration properties. The frictional characteristic of the fabric sample depends on the surface roughness, area of contact, and elastic-plastic deformation of the material. For simplicity, the frictional apparatus developed by TNO is used to assess the fabric surface roughness and fabric toughness. Appendix A illustrates the test apparatus, test protocol, and frictional test results for Samples A, B, C, and D, and a control fabric made from 65 viscose rayon and 35% polyester fiber, using a micro-perforated sleeve and finishing belt hydroentanglement system.

Generally speaking, frictional behavior of polymeric materials is complex, and frictional behavior of a composite structure containing polymeric material is even more complicated. The coefficient of friction is an indication of the surface roughness, the area of contact, and in the case of a composite structure, involves to a great extent structural deformation. Simplified, the frictional force is a summation of adhesive force and deformation force of the total structure. Adhesion wear arises from the shearing of the surface junctions. Some junctions are hooked into the structure, in which case shearing will occur not only in the interface itself, but also at a small distance within the structure of the composite structure.

The frictional results of the test Samples clearly indicate that the intermediate layer 16 provides an important contribution to the lofty, more open internal structure. The higher coefficient of friction of Sample B (rough/rough), and Sample D (rough/rough) is an indication of a higher deformation force being involved, that is, shearing of internal junctions, besides just the adhesive force, which is the shearing of surface junctions.

Sample E was developed to be more durable, with an engineered firm, rough open fibrous structure on the surface, and in the core. There was no significant difference in the coefficient of friction on the rough side of Sample E versus Samples B and D. The soft side of Sample E was, however, measured to have a higher coefficient of friction then Samples B and D. This is most likely a result of the higher deformation force required to overcome the static movement due to the built-in higher internal bonding strength.

Sample A is found to have similar frictional behavior for both expansive surfaces, indicating that the shearing force of surface junctions are dominating. Distinct differences in frictional behavior between opposite surfaces of the fabric are noted on Samples B, C, D, and E.

The control Sample has a coefficient of friction similar to Sample A, but significantly lower than the rough side of Samples B, C, D, and E, and significantly higher than the soft side of Samples B, C, and D. The control fabric is very compact and smooth. Frictional behavior of this type of fabric is clearly dominated by the shearing of surface junctions.

Wiping performance of the various Samples was next evaluated in accordance with the test apparatus and protocol disclosed in Appendix B. This method is directed at the paste removal performance from a surface after a standard wiping movement.

The test data provides certain indications of the comparative fabric performance. The scattered hard binder that was employed was found to penetrate quite an extent through to the other side of Sample A. There is virtually no difference in the coefficient of friction between the hard side and soft side of Sample A, and the fabric core of the Sample is quite compact. It is similar to a spunlace (hydroentangled) fabric made with enhanced durability, without special emphasis in improving the wiping performance, as in Samples B, C, and D. The improved wiping/pick-up properties for Samples B, C, D, and E, suggest that the open fibrous core is providing an important contribution, besides just the fabric surface features. It is believed that it would be expected that total fabric weight, especially the weight in the core, has an important influence on the total wiping/pick-up property of the tested Samples.

The pick-up/wiping performance of the control fabric is slightly better than Sample A. This is because the fabric surface possesses a certain degree of open fibrous characteristics, but it is still inferior in comparison to Samples B, C, and D because of the compact fibrous core. It does not possess the firm, rough/abrasive property, and visible two-sided effect of Samples B, C, and D, which are desired for specific purposes. Table 2 sets forth additional physical data of the tested Samples.

Sample E is presently preferred in view of the capability of maintaining its firm, open fibrous core, even in the wet state. The wiping performance was found to be comparable to that of Sample D, with well-defined, visible bi-functional surfaces.

It is believed that a bi-functional nonwoven fabric wipe in accordance with the present invention can be efficiently manufactured on a generally conventional spunlace (hydroentanglement) process line, particularly if equipped with a pre-bonding apparatus, and a scatter binder application unit suitable for this type of product. Pre-bonding can also be effected by use of bi-component fibers, instead of polyester fibers, both in the core as well as in the fabric layer which provides a hard, abrasive surface. Depending upon the type of spunlace equipment employed, it is not essential to have the pigment binder added onto the abrasive side of the fabric, or onto the soft, absorbent viscose rayon side. Differing colors between the two expansive surfaces of the layered fabric can be achieved by using colored fibers.

While the present disclosure has principally been directed to achieving enhanced surface abrasiveness by adding a very hard binder composition evenly on the surface of the open fibrous side of the fabric, it is, of course, possible to add the hard binder with a pattern to achieve the desired roughness or abrasiveness required for different purposes. Without binder application, it is possible to achieve a “mild” rough or abrasive open surface. The desired differing colors for the expansive surfaces can be achieved through the use of colored fibers.

Openness, compactness, and firmness of the whole composite structure can be engineered for different applications, as desired. The soft absorbent side is also suitable for polishing purposes when an appropriate quantity of ultra-fine or micro-fibers are incorporated therein. As noted, composite structures in accordance with the present invention can be made either with or without apertures. A lower coefficient of friction is expected with an apertured fabric because of the reduced contact surface area of the fabric. Wiping cream or dust can penetrate due to the apertures.

From the foregoing, numerous modifications and variations can be effected without departing from the true spirit and scope of the novel concept of the present invention. It is to be understood that no limitation with respect to the specific embodiments disclosed herein is intended or should be inferred. The disclosure is intended to cover, by the appended claims, all such modifications as fall within the scope of the claims.

TABLE 1
Details of Sample A

| | | |
|---|---|---|
| | | Injectors |
| Sample A | g/m² | ↓ ↓ ↓ ↓ ↓ |

| | | | | |
|---|---|---|---|---|
| Layer | 1 | 100% viscose rayon | * | 24 |
| Layer | 2 | 100% PET | | 0 |
| Layer | 3.1 | 50% 1.7 D′tex viscose/50% 6.7 D′tex | * | 26 |
| | | PET | | |
| | | + scattered binder | | 7 |
| | | | Total Wt. | 57 |

Details of Sample B

| | | |
|---|---|---|
| | | Injectors |
| Sample B | g/m² | ↓ ↓ ↓ ↓ ↓ |

| | | | | |
|---|---|---|---|---|
| Layer | 1 | 100% viscose rayon | * | 24 |
| Layer | 2 | 100% PET | * | 10 |
| Layer | 3.1 | 50% 1.7 D′tex viscose/50% 6.7 D′tex | * | 15.5 |
| | | PET | | |
| | | + scattered binder | | 5.5 |
| | | | Total Wt. | 5.5 |

Details of Sample C

| | | |
|---|---|---|
| | | Injectors |
| Sample C | g/m² | ↓ ↓ ↓ ↓ ↓ |

| | | | | |
|---|---|---|---|---|
| Layer | 1 | 100% viscose rayon | * | 24 |
| Layer | 2 | 100% PET | | 0 |
| Layer | 3.2 | 25% 1.7 D′tex viscose/75% 6.7 D′tex | * | 25 |
| | | PET | | |
| | | + scattered binder | | 5.5 |
| | | | Total Wt. | 54.5 |

Details of Sample D

| | | |
|---|---|---|
| | | Injectors |
| Sample D | g/m² | ↓ ↓ ↓ ↓ ↓ |

| | | | | |
|---|---|---|---|---|
| Layer | 1 | 100% viscose rayon | * | 24 |
| Layer | 2 | 100% PET | * | 10 |
| Layer | 3.2 | 25% 1.7 D′tex viscose/75% 6.7 D′tex | * | 15.5 |
| | | PET | | |
| | | + scattered binder | | 4 |
| | | | Total Wt. | 53.5 |

Details of Sample E

| | | |
|---|---|---|
| | | Injectors |
| Sample E | g/m² | ↓ ↓ ↓ ↓ ↓ |

| | | | | |
|---|---|---|---|---|
| Layer | 1 | 100% viscose rayon | * | 24 |
| Layer | 2 | 100% PET | * | 10 |
| Layer | 3.2 | 25% 1.7 D′tex viscose/75% 6.7 D′tex | * | 15.5 |
| | | PET | | |
| | | + scattered binder to all layers | | 4 |
| | | + scattered binder to surface of layer | | 4 |
| | | | Total Wt. | 57.5 |

TABLE 2
Typical Physical Data

| | | Sample A | Sample B | Sample C | Sample D | Control | Sample E |
|---|---|---|---|---|---|---|---|
| | | Pink+ | Pink | Purple | Blue | Control | Green |
| Weight | g/m² | 57 | 55 | 54.5 | 53.5 | 54.2 | 57.5 |
| MD Tensile | N/ply/25 mm | 4663 | 47.8 | 47.4 | 49.14 | 60 | 60 |
| CD Tensile | N/ply/25 mm | 518 | 4.52 | 4.82 | 4.48 | 7.25 | 6.5 |
| CD | N/ply/25 mm | 403 | 4.44 | 4.27 | 4.59 | 6.66 | 5.5 |
| Bulk | mm/4-ply | 1633 | 1.966 | 1.871 | 2.169 | 182 | 2.25 |

### APPENDIX A

### Frictional Test for NWF

Objective

To determine the coefficient of friction of Nonwovens.

Principle

This test method is aimed at measuring the frictional coefficient of Nonwovens surface.

The apparatus used is made by TNO. TNO is the abbreviation for the official Dutch name: Nederlandse Organisatie voor toegepast-natuurwetenschappelijk onderzoek. The English name is: the Netherlands Organisatin for Applied Scientific Research.

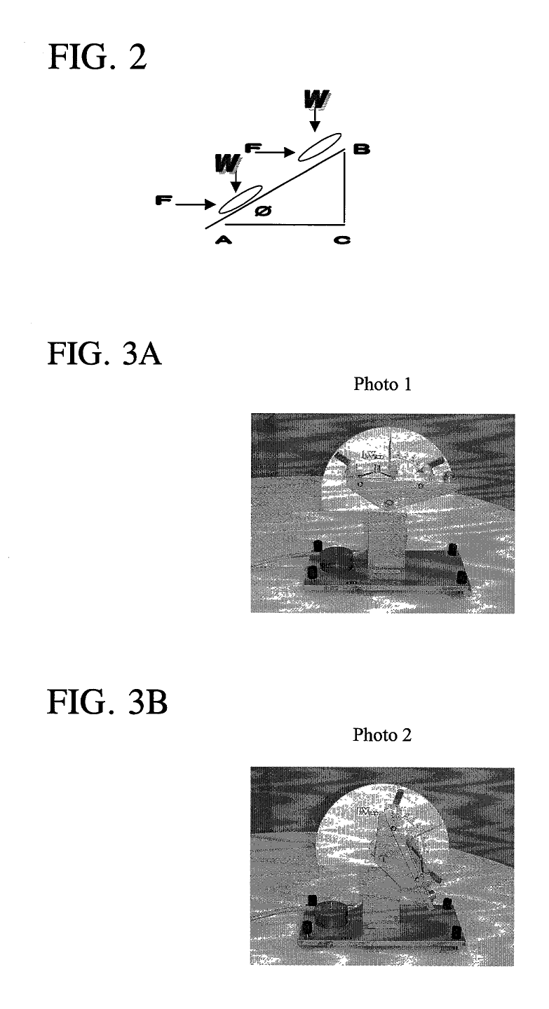

FIG. 2 diagrammatically illustrates the test apparatus, with FIGS. 3A and 3B being photographs thereof.

A weight (mounted with sample) rests on a surface (also mounted with sample) making an angle Ø n to the surface. The horizontal force F necessary to push the body up the slope against gravity moves a horizontal distance AC, while the load W moves a vertical distance BC.

F*AC=W*BC.F/w=TANGENT Ø.

Coefficient of friction (μ)−tan Ø.

Test Conditions

The measurement should be conducted in a laboratory having:

relative humidity=65∓1%, and

temperature=21±1° C.

Test Apparatus

1. IvV TNO friction test apparatus

2. Cutting board.

Procedure

1. Level the apparatus.

2. Mount the test sample (2-ply) 5×15 cm on the bottom plate, and another 2-ply of 3×10 cm on the top weight.

3. Turn the plate to the horizontal position and the pointer is pointing vertical at 0. (photo 1)

4. Start the seitch of the motor to rotate the bottom plate.

5. Release the switch if the top weight is sliding down.

6. Record the reading in degree or direct reading of dynamic coefficient of friction (photo 2).

7. Repeat test according to described procedures using new fabric sample.

Frictional Test Results-Test Samples

| | Sample A | | Sample B | | Sample C | | Sample D | | Sample E | |
|---|---|---|---|---|---|---|---|---|---|---|
| | Pink + | | Pink | | Purple | | Blue | | Green Durable | |
| Top NWF | rough | | rough | | rough | | rough | | rough | |
| Bottom NWF | rough | | rough | | rough | | rough | | rough | |
| | θ | μ | θ | μ | θ | μ | θ | μ | θ | μ |
| Average | 47.40 | 1.09 | 56.10 | 1.49 | 50.80 | 1.23 | 57.70 | 1.59 | 55.10 | 1.44 |
| STDV | 1.17 | 0.04 | 1.37 | 0.08 | 1.32 | 0.06 | 1.57 | 0.10 | 1.91 | 0.10 |
| Top NWF | soft | | soft | | soft | | soft | | soft | |
| Bottom NWF | soft | | soft | | soft | | soft | | soft | |
| | θ | μ | θ | μ | θ | μ | θ | μ | θ | μ |
| Average | 46.20 | 1.04 | 42.80 | 0.93 | 42.50 | 0.92 | 42.00 | 0.90 | 46.50 | 1.06 |
| STDV | 1.23 | 0.04 | 2.10 | 0.07 | 1.78 | 0.06 | 2.62 | 0.08 | 1.72 | 0.06 |

The control fabric is made with fabric construction—65& viscose rayon fiber/±35% polyester fiber, using micro-perforated sleeve+finishing belt system. The control fabric is compact, soft, and smooth on both sides.

Frictional Test Results - Control Fabric

| Top NWF - soft | Control | Control |
|---|---|---|
| Bottom NWF - soft | θ | μ |
| Average | 48 | 1.123 |
| STDV | 0.82 | 0.03 |

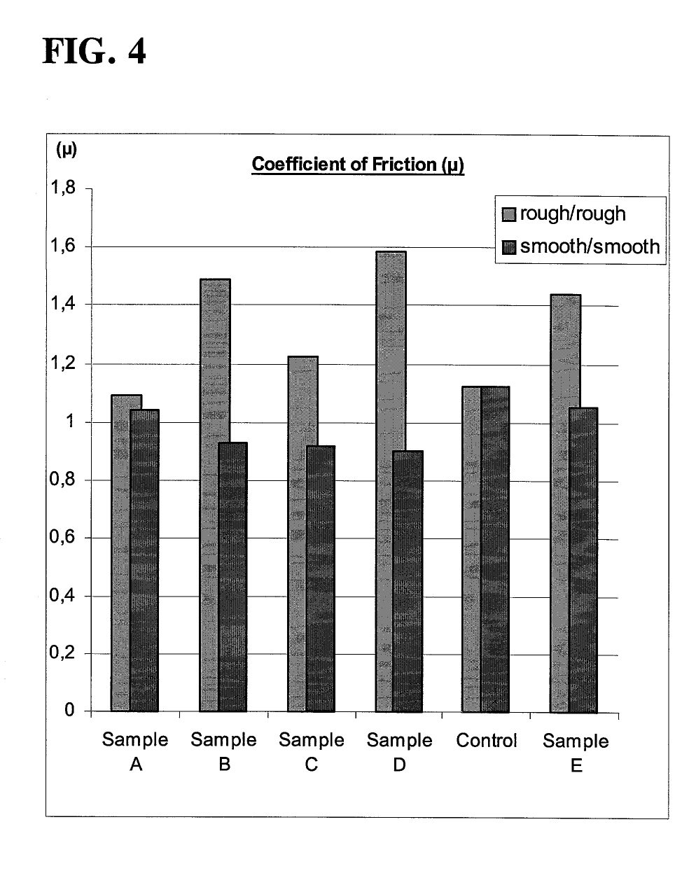

FIG. 4 is a graph of frictional coefficient data for the tested samples.

### Wiping Performance

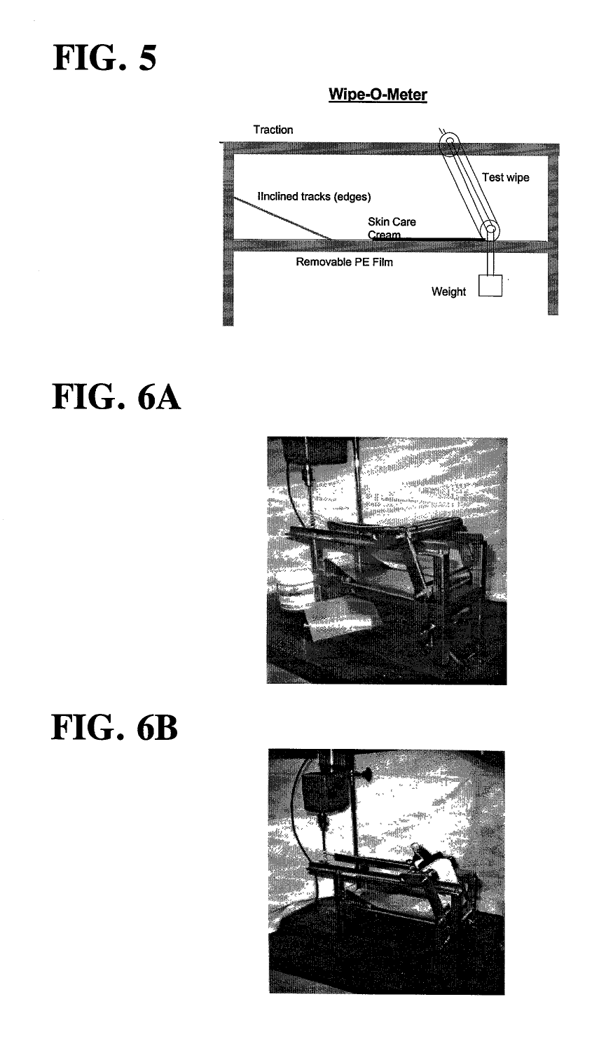

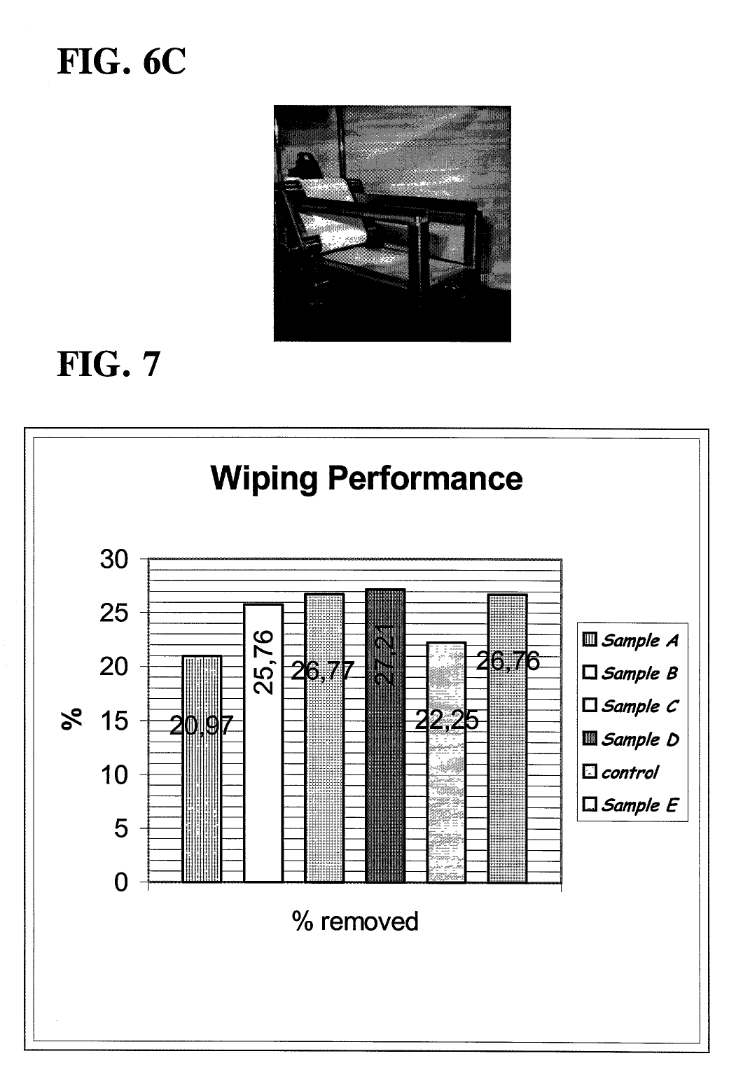

Wiping/cleaning performance is evaluated by using the Wipe-O-Meter. FIG. 5 diagrammatically illustrates this test apparatus, as further shown in ghe photographs of FIGS. 6A, 6B, and 6C.

### Wiping Performance Test for NWF Wipes

Objective

To determine the wiping performance of nonwovens—pick-up on nonwovens surface.

Principle

Wipes made out of nonwovens can be used to wipe off dirt which can be in the form of dust, liquid, oil/cream/paste (combination of dirt and liquid, and in some cases, oil and oil and liquid with emulsifier).

This test method is aimed at the paste removal performance from a surface after a standard wiping movement.

The paste specified for this test is the NIVEA® Skin Care Cream from Beiersdorf AG. This cream is chosen because of its low evaporation factor, and this gives better accuracy in the weight determination before and after tests.

Test Conditions

The measurement should be conducted in a laboratory having:

relative humidity=65±1%, and

temperature=21±1° C.

Test Apparatus

1. Balance with accuracy of 0.001 g

2. Cutting Board

3. Wipe-O-Meter as described

4. Cream application template (made from Ultra-High Molecular Weight Polyethylene Plastic, 0.4 mm thick, punched with 75 holes evenly distributed in 3×6 cm²), and the scraping plate.

5. Variable drive like Lab mixer or variable speed drive

6. Stop watch

7. Cream/paste as specified or any other medium

Procedure

1. Calibrate the wiping speed—control the connecting wire between the Wipe-O-Meter and variable drive spindle is well tightened. Adjust the spindle speed so that the roll from the start marrk to the end mark on the wiping plate is between 5 sec±10%.

2. Mount the test sample 10×40 cm on the rollers.

3. Place the PELD film (11 cm w×40 cm l) on the balance and tare the balance.

4. Position lthe application template 13 cm from one end of the PELD film, and apply on the template some cream. Scrape the cream on the template so that a total of 75 holes of the template are covered with cream.

5. Record the weight (W1) of cream applied on the film to 0.001 g accuracy.

6. Place the PELD film with cream dots in the Wipe-O-Meter without touching the test sample mounted on, and fix the film with the clamp.

7. Start the wiping test by starting the drive of the clibrated variable speed motor.

8. Stop the motor as soon as the bottom role with fabric sample is lifted from the film.

9. Record the wright (W2) of the cream left on the film in 0.001 g accuracy.

10. The difference (W3)=(W1)−(W2) is the amount of cream recovered.

11. The ratio in % is sometimes more meaningful in comparing wiping performance for different fabrics.

12. Repeat test according to described procedures using new fabric and new film.

Wiping Performance Of Test Samples And Control

| Sample A | | | | Sample C | | | |
|---|---|---|---|---|---|---|---|
| rough side | | | | rough side | | | |
| | wt. begin | wt. end | wt. removed | | wt. begin | wt. end | wt. removed |
| Average | 0.408 | 0.322 | 0.086 | Average | 0.414 | 0303 | 0.111 |
| SD | 0.095 | 0.095 | 0.002 | SD | 0.109 | 0.108 | 0.005 |
| % | 100 | 79.03 | 20.97 | % | 100 | 73.23 | 26.77 |
| Sample B | | | | Sample D | | | |
| rough side | | | | rough side | | | |
| | wt. begin | wt. end | wt. removed | | wt. begin | wt. end | wt. removed |
| Average | 0.393 | 0.292 | 0.101 | Average | 0.415 | 0.302 | 0.113 |
| SD | 0.045 | 0.049 | 0.008 | SD | 0.120 | 0.121 | 0.004 |
| % | 100 | 74.24 | 25.76 | % | 100 | 72.79 | 27.21 |
| | | | | Sample E | | | |
| | | | | rough side | | | |
| Control | | | | | wt. begin | wt. end | wt. removed |
| Average | 0.438 | 0.341 | 0.098 | Average | 0.398 | 0.292 | 0.107 |
| SD | 0.092 | 0.095 | 0.007 | SD | 0.038 | 0.033 | 0.018 |
| % | 100 | 77.75 | 22.25 | % | 100 | 73.24 | 26.76 |

### Wiping Performance

Wiping performance is graphically illustrated in the graph of FIG. 7.

Typical Physical Data

| | | Sample A | Sample B | Sample C | Sample D | Control | Sample E |
|---|---|---|---|---|---|---|---|
| | | Pink + | Pink | Purple | Blue | Control | Green |
| Weight | g/m² | 57 | 55 | 54.5 | 53.5 | 54.2 | 57.5 |
| MD | N/ply/25 mm | 46.63 | 47.8 | 47.4 | 49.14 | 60 | 60 |
| Tensile | | | | | | | |
| CD | N/ply/25 mm | 5.18 | 4.52 | 4.82 | 4.48 | 7.25 | 6.5 |
| Tensile | | | | | | | |
| CD Wet | N/ply/25 mm | 4.03 | 4.44 | 4.27 | 4.59 | 6.66 | 5.5 |
| Tensile | | | | | | | |
| Bulk | mm/4-ply | 1.633 | 1.966 | 1.871 | 2.169 | 1.82 | 2.25 |

What is claimed is:

1. A bi-functional nonwoven fabric wipe, comprising:
a hydroentangled composite fibrous matrix having first and second opposite expansive surfaces,
said first expansive surface being provided by a first outer layer of said composite fibrous matrix, and exhibiting a relatively soft, smooth surface texture,
said second expansive surface being provided by a second outer layer of said composite fibrous matrix, and exhibiting a relatively abrasive surface texture,
whereby the differing surface textures of said opposite expansive surface provide bi-functional characteristics for said wipe.

2. A bi-functional nonwoven fabric wipe in accordance with claim 1, wherein:
said first and second expansive surfaces of said composite fiber matrix are of differing colors.

3. A bi-functional nonwoven fabric wipe in accordance with claim 2, wherein:
said differing colors of said first and second expansive surfaces comprise colored fibrous elements provided in one of said first and second outer layers of said composite fibrous matrix.

4. A bi-functional nonwoven fabric wipe in accordance with claim 2, wherein:
said differing colors of said first and second expansive surfaces comprise a colored binder composition applied to said second expansive surface, said binder composition enhancing surface abrasiveness of said second expansive surface.

5. A bi-functional nonwoven fabric wipe in accordance with claim 1, including:
a binder composition applied to said second expansive surface for enhancing surface abrasiveness of said second expansive surface.

6. A bi-functional nonwoven fabric wipe in accordance with claim 5, wherein:
said binder composition is scatter-applied.

7. A bi-functional nonwoven fabric wipe in accordance with claim 5, wherein:
said binder composition is pattern-applied.

8. A bi-functional nonwoven fabric wipe in accordance with claim 1, wherein:
said first outer layer of said composite fibrous matrix substantially entirely comprises cellulosic fibrous material, and said second outer layer comprises a blend of cellulosic fibrous material and synthetic fibrous material.

9. A bi-functional nonwoven fabric wipe in accordance with claim 8, wherein:
said cellulosic fibrous material consists essentially of rayon fibers.

10. A bi-functional nonwoven fabric wipe in accordance with claim 8, wherein:
said blend comprises rayon fibrous material and PET fibrous material.

11. A bi-functional nonwoven fabric wipe in accordance with claim 1, wherein:
said composite fibrous matrix further comprises an intermediate layer positioned between said first and second outer layer.

12. A bi-functional nonwoven fabric wipe in accordance with claim 11, wherein:
said intermediate layer consists essentially of synthetic fibers, each of said first and second outer layers comprising cellulosic fibers.

13. A bi-functional nonwoven fabric wipe in accordance with claim 11, wherein:
said first outer layer consists essentially of rayon fibers, and said second outer layer comprises a blend of PET fibers and rayon fibers.

14. A bi-functional nonwoven fabric wipe in accordance with claim 11, including:
a binder composition applied to said second expansive surface of said second outer layer for enhancing surface abrasiveness.

15. A bi-functional nonwoven fabric wipe in accordance with claim 1, wherein:
said fabric wipe is apertured.
